(19) United States
(12) Patent Application Publication
(10) Pub. No.: US 2014/0280338 A1
(43) Pub. Date: Sep. 18, 2014

(54) DISTRIBUTED NETWORK ANALYTICS

(71) Applicant: CISCO TECHNOLOGY, INC., San Jose, CA (US)

(72) Inventors: Chris METZ, Danville, CA (US); Saileshwar KRISHNAMURTHY, Palo Alto, CA (US); Rex FERNANDO, San Jose, CA (US); Jisu BHATTACHARYA, San Jose, CA (US); David WARD, San Jose, CA (US)

(73) Assignee: Cisco Technology, Inc., San Jose, CA (US)

(21) Appl. No.: 13/830,062

(22) Filed: Mar. 14, 2013

(51) Int. Cl. G06F 17/30

(52) U.S. Cl. CPC G06F 17/30533
USPC 707/774

(57) ABSTRACT

In an embodiment, a method comprises receiving, at an analytics engine, from a separate analytics application, an analytics query for data that is potentially available in data streams of networked computing devices; sending, to a distributed network analytics controller, sub-queries based on the analytics query; determining distributed network analytics agents capable of executing each of the sub-queries; sending instructions to the agents to initiate the sub-queries for the data at specified locations; initiating execution of the sub-queries on data streams that are locally available at one of the networked computing devices at which the agents are running; forming summarized data streams and zero or more raw data streams at the networked computing devices having the analytics agents; sending the summarized data streams and the zero or more raw data streams to the analytics engine; wherein the method is performed by computing device(s).

### FIELD OF THE INVENTION

The present disclosure relates to management of computer networks. The disclosure relates more specifically to techniques for collecting and analyzing network analytics data useful in network management, including responding to queries for network analytics data.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In network management, “network analytics” generally refers to data, obtained from data plane elements or control plane elements, that a network operator collects, stores and processes for use in optimizing and/or monetizing elements of network infrastructure such as routers and switches. Examples of network analytics data include, but are not limited to, Netflow data, IPFix data, BGP/IGP topology data, SNMP MIB object values, user activity data records from a Deep Packet Inspection (DPI) engine, and session accounting statistics data. Network analytics is of interest to network service providers as well as business enterprises.

In a network comprising N devices, obtaining network analytics data typically requires configuring the N devices to generate and export analytics data to collection points comprising C remote centralized collectors. Such an arrangement has numerous drawbacks. For example, the configuration overhead for the operator is O(N). The network resources that are consumed may be O(N*C). For example, if a router is configured to export Netflow packets to collectors C1, C2, C3, then the router CPU, memory and network interfaces must be consumed to generate, replicate and unicast the Netflow packets to all three collectors.

A further drawback involves delay or latency in analyzing and acting upon the analytics data; delays occur between the time when the analytics data is generated, transmitted over the network and analyzed at the collector sites. The effect of latency can be significant when interpretation of network analytics is necessary to evaluate or respond to a network failure or security attack. Moreover, applications that need the analytics data typically assume that all necessary data for a query is available at the collector site; if it is not, then a query from an application may yield incomplete or erroneous results. If the network operator discovers the incomplete or erroneous results, then the network operator typically is required to manually reconfigure the N network elements to provide new data, and cause the application to re-present the query. Manual coordination between users of analytics applications and the network operator may be needed to determine when the query can be re-presented for processing with a better data set.

Another drawback is the communication overhead associated with transmitting detailed analytics data over the network. Network capacity is precious and operators often prefer to use these resources judiciously and in order to serve direct business needs. For example, it would not be acceptable to have the communication of detailed analytics data starve legitimate and critical business operations of the bandwidth they need.

### BRIEF DESCRIPTION OF THE DRAWINGS

In the drawings:

FIG. 1 illustrates a configuration of a distributed network analytics system, in one example embodiment.

FIG. 2A, FIG. 2B collectively illustrate a process of obtaining summarized data from a plurality of distributed network analytics agents, in one example embodiment.

FIG. 2C illustrates a process of operating a distributed network analytics system, in one example embodiment or use case.

FIG. 3 illustrates various arrangements by which a distributed network analytics agent may be implemented, in one example embodiment.

FIG. 4 illustrates a computer system with which some embodiments may be implemented.

### DESCRIPTION OF EXAMPLE EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1.0 Overview

In an embodiment, a method comprises receiving, at any of one or more analytics engines each hosted on one or more computing devices, from a separate analytics application, an analytics query for data that is potentially available in one or more data streams of one or more networked computing devices; sending, to a distributed network analytics controller, one or more sub-queries based on the analytics query; determining one or more distributed network analytics agents capable of executing each of the one or more sub-queries; sending instructions to the agents to initiate the one or more sub-queries for the data at one or more specified locations; initiating execution of the one or more sub-queries on one or more data streams that are locally available at one of the one or more networked computing devices at which the agents are running; forming one or more summarized data streams and zero or more raw data streams at the one of the one or more networked computing devices of the analytics agents; sending the one or more summarized data streams and the zero or more raw data streams to the analytics engine; wherein the method is performed by one or more computing devices.

In an embodiment, a data processing method comprises receiving, at any of one or more analytics engines each hosted on one or more computing devices, from a separate analytics application, an analytics query for data that is potentially available in one or more data streams of one or more networked computing devices; rewriting the analytics query into one or more sub-queries configured to operate on specific raw data streams to produce resulting raw or summarized data streams, and a super-query that is configured to consolidate the resulting raw or summarized data streams to produce results for the analytics query; initiating, at the analytics engine, execution of the super-query; sending, from the analytics engine to a distributed network analytics controller, the one or more sub-queries and one or more locations to send the one or more resulting raw or summarized data streams; determining, at the distributed network analytics controller, one or more distributed network analytics agents capable of executing each of the one or more sub-queries; sending, from the distributed network analytics controller to one or more analytics agents respectively hosted by the one or more networked computing devices, instructions to initiate the one or more sub-queries for the data and the one or more locations; in response to the instructions received at each particular one of the one or more analytics agents at the one or more networked computing devices, performing: initiating execution of the sub-queries on the one or more data streams that are locally available at one of the one or more networked computing devices at which that particular one of the analytics agents is running; forming one or more summarized data streams and zero or more raw data streams at the one of the one or more networked computing devices at which that particular one of the analytics agents is running; sending the one or more summarized data streams and the zero or more raw data streams to the desired location at the analytics engine; wherein the method is performed by one or more computing devices.

In an embodiment, a data processing apparatus comprises a first computer configured to execute a network analytics application; a second computer that is coupled to the first computer and comprising an analytics engine; a third computer that is coupled to the second computer and comprising a distributed network analytics controller; one or more distributed network analytics nodes, coupled to the second and third computers, and each comprising an analytics agent; the computers comprising non-transitory computer-readable storage media storing instructions which when executed cause performing a data processing method comprising:

receiving, at any of one or more analytics engines each hosted on one or more computing devices, from a separate analytics application, an analytics query for data that is potentially available in one or more data streams of one or more networked computing devices; rewriting the analytics query into one or more sub-queries configured to operate on specific raw data streams to produce resulting raw or summarized data streams, and a super-query that is configured to consolidate the resulting raw or summarized data streams to produce results for the analytics query; initiating, at the analytics engine, execution of the super-query; sending, from the analytics engine to a distributed network analytics controller, the one or more sub-queries and one or more locations to send the one or more resulting raw or summarized data streams; determining, at the distributed network analytics controller, one or more distributed network analytics agents capable of executing each of the one or more sub-queries; sending, from the distributed network analytics controller to one or more analytics agents respectively hosted by the one or more networked computing devices, instructions to initiate the one or more sub-queries for the data and the one or more locations; in response to the instructions received at each particular one of the one or more analytics agents at the one or more networked computing devices, performing: initiating execution of the sub-queries on the one or more data streams that are locally available at one of the one or more networked computing devices at which that particular one of the analytics agents is running; forming one or more summarized data streams and zero or more raw data streams at the one of the one or more networked computing devices at which that particular one of the analytics agents is running; sending the one or more summarized data streams and the zero or more raw data streams to the desired location at the analytics engine.

In an embodiment, one or more non-transitory computer-readable storage media store instructions which when executed cause performing a data processing method comprising: receiving, at any of one or more analytics engines each hosted on one or more computing devices, from a separate analytics application, an analytics query for data that is potentially available in one or more data streams of one or more networked computing devices; rewriting the analytics query into one or more sub-queries configured to operate on specific raw data streams to produce resulting raw or summarized data streams, and a super-query that is configured to consolidate the resulting raw or summarized data streams to produce results for the analytics query; initiating, at the analytics engine, execution of the super-query; sending, from the analytics engine to a distributed network analytics controller, the one or more sub-queries and one or more locations to send the one or more resulting raw or summarized data streams; determining, at the distributed network analytics controller, one or more distributed network analytics agents capable of executing each of the one or more sub-queries; sending, from the distributed network analytics controller to one or more analytics agents respectively hosted by the one or more networked computing devices, instructions to initiate the one or more sub-queries for the data and the one or more locations; in response to the instructions received at each particular one of the one or more analytics agents at the one or more networked computing devices, performing: initiating execution of the sub-queries on the one or more data streams that are locally available at one of the one or more networked computing devices at which that particular one of the analytics agents is running; forming one or more summarized data streams and zero or more raw data streams at the one of the one or more networked computing devices at which that particular one of the analytics agents is running; sending the one or more summarized data streams and the zero or more raw data streams to the desired location at the analytics engine.

2.0 Structural & Functional Example

In an embodiment, a programmatic method enables network analytics applications to request the collection of additional information from the network to fulfill a new query that avoids imposing the burden of O(N) manual configuration on a network operator when it is determined that not all data is present in a database at the collector and analytics site when a query is presented. In an embodiment, a distributed network analytics system enables programming network elements to perform analytics collection and processing in a distributed virtual or physical network environment. Benefits include improved scalability, an organized hierarchy of collection elements, reduced consumption of network capacity, and the introduction of an abstraction layer that provides more efficient configuration of large networks for analytics. Typically the data sources comprise unbounded continuous data sources or streams.

FIG. 1 illustrates a configuration of a distributed network analytics system, in one example embodiment. One embodiment is configured generally to facilitate analytics with respect to a network 130 that comprises a plurality of routers, switches, and other elements of networking infrastructure denoted R1, R2; other routers and switches configured with distributed network analytics nodes, as further described herein, are denoted D1, D2, Dn and any number of such routers, switches and nodes may be present. The network 130 is the subject of analytics and may be owned, operated or used by a network service provider, Internet service provider, business enterprise, or other network operator.

A data center or cloud processing facility 120, typically in a specified or centralized location, comprises sufficient CPU, memory and storage resources to execute analytics applications that process large quantities of analytics data. The data center may comprise one or more analytics applications 126 and a centralized analytics engine 124 with one or more tightly coupled query processing nodes which are integrated with collectors 122, a database 128 and other storage for data archiving. “Centralized,” in this context, means separate from the nodes D1, D2, Dn but otherwise does not require any particular geographic location. In some embodiments, “centralized” may refer to elements that are co-located with other elements, for example, in the same data center. In some embodiments, analytics engine 124 is hosted on a first computer, analytics applications 126 are hosted on a second computer, and the controller 102 is hosted on a third computer. Alternatively, applications 126 and engine 124 may use the same computer.

In an embodiment, a distributed network analytics system comprises a plurality of distributed analytics nodes denoted D1, D2, Dn, a distributed network analytics controller 102, and the centralized analytics engine 124. In an embodiment, each of the distributed analytics nodes may be implemented as any of a router with a service blade, a physical appliance, a virtual appliance, or other computing device, as described further herein for FIG. 3. In one implementation, computer program code which, when executed, performs the functions of a distributed analytics node may be integrated into the executable operating system image of a network infrastructure element such as a router; in this manner, the distributed network analytics node is available at a physical network node and can be selectively activated or awakened upon command from the distributed network analytics controller, as further described herein. In another implementation, as further described, Interface to the Internet Routing System (I2RS) may be used to deploy new distributed network analytics nodes dynamically at a location proximate to a specified data source.

In an embodiment, each of the distributed analytics nodes comprises a local collector unit 140 that is configured to process raw input data streams, a local analytics processing unit 142 configured to execute one or more queries against the raw input data streams, and a memory 144 configured to cache the query summaries. In an embodiment, each of the distributed analytics nodes comprises a distributed network analytics agent 304 that is configured to communicate with the distributed analytics controller 102 or with a proxy controller, as well as with the collectors 122 associated with centralized analytics engine 124.

Each of the distributed analytics nodes may be configured as a “query” or Q node only to run queries, to cache the query summaries locally and to forward the query summaries to the centralized analytics engine 124 in the data center; in this configuration, raw input data is not retained. Alternatively, one or more of the distributed analytics nodes may be configured to run queries, to cache the query summaries locally and to forward the query summaries to the data center 120, as indicated by arrows 136, and also to store or retain collected raw input data in a local repository 132 in addition to forwarding to the data center. In this configuration, the distributed analytics node comprises storage sufficient to store the raw collected data for subsequent upload to the data center. A node of this type may be termed a “query-retain” (QR) node. A distributed analytics node in either of the configurations may comprise a user interface configured to enable an operator to obtain a local view of the query summaries at that distributed analytics node.

In an embodiment, the centralized analytics engine 124 comprises one or more computer programs or other software elements executed in a host computer and configured to provide an application programming interface (API) 104 or other abstraction layer that represents and provides access to the underlying network analytics collection and processing capabilities to an analytics application, including access to distributed network analytics nodes D1, D2, Dn. Analytics engine 124 is configured to communicate one or more sub-queries 133 to controller 102 after rewriting a query received from one of the applications 126 via API 104, as further described in detail in other sections. In an embodiment, the distributed network analytics controller 102 also is configured to dynamically track and program one or more of the distributed analytics nodes, to cause reconfiguring the one or more of the distributed analytics nodes to collect different data, as indicated by arrow 134.

In this context, to “program” the distributed network analytics nodes refers to providing instructions in a query programming protocol that the nodes can interpret to result in self-configuration with a specific query to be executed locally at the nodes. The protocol includes a payload containing a query in a query programming language and instructions that identify the input data for the query, where the input data must be acquired from, retention policies for query outputs as well as result disposition information for the output of the query. An example of a query programming protocol is I2RS, but other embodiments may use different programming techniques. For example, messaging over the OpenFlow application layer transport protocol, or an XML variant, or a YANG data model may be used. The query programming language can be of the type implemented in products of Truviso, Inc. or another suitable candidate such as the query language that is described in, for example, A. Arasu et al., “The Continuous Query Language: Semantic Foundations and Query Execution,” publication 2003-67, Stanford University Department of Computer Science (2003), 32 pp.

A protocol such as I2RS may be used, for example, to identify a raw input data stream and one or more derived data sources without interaction with the application that provided a query, and to route the propagation and processing of the data streams and derived data sources to one or more distributed network analytics nodes. In effect, an embodiment can provide a dynamically instantiated overlay network of distributed network analytics nodes that can accomplish what the application query is seeking.

In an embodiment, the distributed network analytics controller 102 is configured to maintain a database of the distributed analytics nodes that may be viewed as a topology 110 of the nodes. In an embodiment, the distributed network analytics controller 102 further is configured to provide a distributed network analytics policy engine 112. The policy engine may be configured to store data retention definitions, sampling rates, or other descriptions about how to treat data derived from various sources.

In an embodiment, the distributed network analytics controller is further configured to provide a programmer unit 106 for signaling or programming queries, data models, input streams, retention and upload policies on the distributed network analytics controller nodes. In an embodiment, the distributed network analytics controller 102 further comprises a data collector 108 that is configured to discover and learn topology information relating to the distributed analytics nodes D1, D2, Dn for purposes of populating topology 110.

A benefit of this arrangement is that the API 104 of the centralized analytics engine 124, in combination with the operation of the distributed analytics nodes D1, D2, Dn, provides a complete abstraction layer for network analytics collection and processing functions.

In one embodiment, a distributed network analytics node D1, D2, Dn in either the query-only configuration or the query-retain configuration may be configured as a distributed network analytics controller 102 for a set of routers R1, R2 or for other distributed network analytics nodes D1, D2, Dn.

In various embodiments the distributed network analytics controller 102 is hosted in a first computer of a network operations center and the separate analytics application 126 is hosted in a second computer of the same network operations center and the separate analytics engine 124 is hosted in a third computer of the same network operations center, or the controller 102 and application 126 and engine 124 may be hosted on separate computers in the same data center 120 or in different locations or centers.

FIG. 2A, FIG. 2B collectively illustrate a process of obtaining summarized data from a plurality of distributed network analytics agents, in one example embodiment.

Operation 202 comprises receiving, at a network analytics engine, from a separate analytics application, an analytics query for data that is potentially available in one or more data streams of one or more networked computing devices. In one embodiment, the analytics engine 124 receives the query via API 104 from one of the applications 126.

At operation 204, the analytics engine rewrites the analytics query into one or more sub-queries configured to operate on specified raw streams to produce resulting raw or summarized data streams, and a super-query configured to consolidate the resulting raw or summarized data streams to produce results for the analytics query. For example, analytics engine 124 rewrites the query provided by applications 126 into a super-query and one or more sub-queries. At operation 206, the analytics engine initiates execution of the super-query.

At operation 208, the analytics engine sends, to a separate distributed network analytics controller that controls distributed analytics agents, the one or more sub-queries and also locations to send the resulting raw or summarized data streams. For example, analytics engine 124 sends sub-queries 133 to controller 102.

At operation 210, the distributed network analytics controller determines one or more of the distributed analytics agents capable of executing each of the one or more sub-queries. For example, based on policy 112 and topology 110, the programmer 106 of controller 102 determines which of the nodes D1, D2, Dn has an agent that is capable of executing a particular sub-query.

At operation 212, the process performs sending, from the distributed network analytics controller to one or more analytics agents respectively hosted by the one or more networked computing devices, instructions to initiate one or more of the sub-queries for the data using the specified locations. For example, as seen in FIG. 1, the controller 102 distributes sub-queries 134 and location information to the nodes for execution at the agents 304 at those nodes.

At operation 214, in response to the instructions, each particular one of the one or more analytics agents at the one or more networked computing devices initiates execution of the one or more sub-queries on the one or more data streams that are locally available at one of the one or more networked computing devices at which that particular one of the analytics agents is running. For example, an agent 304 initiates execution of one of the sub-queries 134. At operation 218, the analytics agents form one or more summarized data streams and zero or more raw data streams at the one of the one or more networked computing devices at which that particular one of the analytics agents is running. Operation 220 comprises sending the one or more summarized data streams and the zero or more raw data streams to the analytics application. As seen in FIG. 1, summarized data streams 136 and raw data streams are sent from nodes D1, D2, Dn to the collectors 122 associated with the analytics engine 124. In an embodiment, the sending comprises sending to the first analytics agent on a first service blade of a data packet router and sending to the second analytics agent on a second, different service blade of the same data packet router.

Embodiments may be configured to process a simple query or a compound query. In an embodiment, a simple query is one for which the distributed network analytics nodes receive the complete raw input stream and can run the complete set of queries (super-query and one or more sub-queries) against it. In an embodiment, a compound query is one where the distributed network analytics nodes do not have enough information and/or processing resources to run and complete the query. In this case, the distributed network analytics node may communicate requests directly to hardware or firmware elements of network infrastructure elements for the purpose of causing collection of needed information; later, the distributed network analytics node collects, from the hardware or firmware elements, enough information to respond to the application query. In another embodiment, a compound query is one where the results of a sub-query that is produced on a given distributed network analytics node is sent as input to one or more other sub-queries that are run on one or more other distributed network analytics nodes instead of, or in addition to, sending the results to the super-query running on the analytics engine. Embodiments may be configured to operate on hierarchical queries at any of the distributed network analytics nodes. For example, a first query Q1 on an input stream may result in a first query summary QS1. Second and third queries Q2, Q3 then may operate using QS1 as the input stream.

For example, assume that the network operator wants to count all packets going to prefix 16.1.9/24 through a tunnel TE1 originating on the network element. In this case, separately counting all packets going to prefix 16.1.9/24 and counting all packets directed through tunnel TE1 may be performed by independent packet counting functions. But because these packet counting functions are independent, and the counts cannot be merged using conventional collection techniques. In an embodiment, the distributed network analytics node can program or position one or more sub-queries (of a super-query) on hardware, firmware or software associated with a distributed component of a network element. An example would be to perform the sub-queries on one or more distributed packet forwarding linecards found on commonly deployed large-scale distributed routers in service provider networks. As a result, the distributed network analytics node can now receive and merge the results of the specific sub-queries performed on the linecards.

Thus, in some embodiments the analytics query from the separate analytics application is a compound query and operation of a process further comprises sending, from the distributed network analytics controller to a first analytics agent hosted by a first one of the networked computing devices, first instructions to initiate a first programmed analytics query for the data, wherein the first programmed analytics query relates to the compound query; sending, from the distributed network analytics controller to a second analytics agent hosted by a second, different one of the networked computing devices, second instructions to initiate a second programmed analytics query for the data, wherein the second programmed analytics query also relates to the compound query; in response to the first instructions and the second instructions, the first analytics agent and the second analytics agent respectively sending, to the analytics application, a first summarized data stream resulting from the first programmed analytics query and a second summarized data stream resulting from the second programmed analytics query.

FIG. 2C illustrates a process of operating a distributed network analytics system, in one example embodiment. FIG. 2C represents just one example use case to illustrate various benefits of the embodiments of FIG. 1, FIG. 2A, FIG. 2C, FIG. 3.

At operation 250, a network operator experiences one or more of the problems that have been previously described; for example, a network application performs erroneously or poorly in violation of service-level agreements. In response in order to understand the health and state of the network, at operation 252, the operator deploys a distributed network analytics controller and a plurality of distributed network analytics nodes and centralized analytics engines. Deployment, in this context, may comprise sending a specified activation command to one or more routers, switches, or other infrastructure elements of the network 130 to cause the controller and nodes to initiate operation on those elements.

At operation 254, the collector unit of the distributed network analytics controller discovers the presence of the distributed network analytics nodes and updates topology records in the database of the distributed network analytics controller.

At operation 256, the distributed network analytics controller receives, from an analytics application via the analytics API, a query for information. At operation 258, the distributed network analytics controller invokes the policy engine and obtains topology data to determine which particular distributed network analytics nodes, input streams, data models, and/or queries are needed to respond to the query. The distributed network analytics controller then conveys information describing the distributed network analytics nodes, input streams, data models, and/or queries to the analytics engine as requested.

At operation 260, the programmer unit establishes a connection to the distributed network analytics agent of each particular distributed network analytics node. At operation 262, a distributed network analytics agent of one particular distributed network analytics node receives the descriptive information and dynamically configures and activates the appropriate input streams, data models, and/or queries.

At operation 264, depending on the configuration of the policy applicable to the situation, one or more query summaries are cached, uploaded to the centralized collector sites, and the raw input is retained or discarded.

Operations 260 to 264 may be repeated as necessary to ensure that the correct data is collected and processed in a timely manner. Further, evaluation of the query summaries at the collectors of the data center may result in re-performing operations 256 to 264 for other queries depending on the results received for a first query.

As another example of operation, a network operator may start an individual data stream from a specific source, typically a specific set of records from a given network element, or may start a data stream from a specific family of sources in a specific geography. In response, the distributed network analytics controller is configured to determine whether a distributed network analytics node is then currently operating in the vicinity of the newly specified data stream. If no distributed network analytics node is in the vicinity of the newly specified data stream, then the distributed network analytics controller may initiate operation of a distributed network analytics node at that location, and direct the newly specified data source to the newly instantiated distributed network analytics node. Finally, the original query that the distributed network analytics controller has received from an application may be distributed into the network as a set of separate sub queries, each of which is provided to a different distributed network analytics node that can access a data stream that can yield complete results for that sub query.

FIG. 3 illustrates various arrangements by which a distributed network analytics agent may be implemented, in one example embodiment.

As seen in view (A), in one embodiment, a computer 302 may host a distributed network analytics agent 304 that is configured to collect data from any one or more of routers R1, R2, Rn. Alternatively, as in view (B), a router R1 may host distributed network analytics agent 304 using processing and storage resources in the router itself.

If the router uses a multiple blade architecture, as seen in view (C), then a blade 306 may host the distributed network analytics agent 304 and there may be any number of blades with agents within a particular router R1.

Further, as seen in view (D), a router R1 may comprise one or more virtual machines 308, 310 each hosting a different, independent instance of distributed network analytics agent 304 for use in collecting data obtained by router R1, perhaps on different raw streams or different derived streams. For example the first virtual machine 308 may run a first distributed network analytics agent 304 that processes a raw stream as input and produces a first derived stream DS1, and the second virtual machine 310 may execute a second distributed network analytics agent 304 that is configured to obtain the first derived stream DS 1 as input and produce a second derived stream DS2. Alternatively the results of the first stream may be fed to another query to the same virtual machine's analytics agent.

Using the approaches herein, distributed network analytics provides an effective method for programming the collection and processing of network analytics data in a distributed virtual or physical network environment. Embodiments can achieve greater scalability, can provide the benefits of hierarchical organization, and can introduce a beneficial abstraction layer to simplify the interaction of analytics applications with a data collections infrastructure. Distributed query processing may be performed using a large number of distributed elements. As a result, in certain embodiments, the O(N) configuration overhead of prior embodiments may be reduced as low as O(1), because the distributed network analytics controller exerts dynamic, programmatic control and provisioning over the distributed network analytics nodes. Applications are not required to obtain or analyze the topology of the distributed network analytics nodes or obtain data describing the particular collection capabilities of the nodes; instead, applications can interact with the system through an API by directing requests to the distributed network analytics controller, which is configured to program the distributed network analytics nodes dynamically to collect result data required by the applications or raw data appropriate for complete execution of queries that the application requires.

3.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

4.0 Other Disclosure

1. A data processing method comprising: receiving, at any of one or more analytics engines each hosted on one or more computing devices, from a separate analytics application, an analytics query for data that is potentially available in one or more data streams of one or more networked computing devices; rewriting the analytics query into one or more sub-queries configured to operate on specific raw data streams to produce resulting raw or summarized data streams, and a super-query that is configured to consolidate the resulting raw or summarized data streams to produce results for the analytics query; initiating, at the analytics engine, execution of the super-query; sending, from the analytics engine to a distributed network analytics controller, the one or more sub-queries and one or more locations to send the one or more resulting raw or summarized data streams; determining, at the distributed network analytics controller, one or more distributed network analytics agents capable of executing each of the one or more sub-queries; sending, from the distributed network analytics controller to one or more of the analytics agents respectively hosted by the one or more networked computing devices, instructions to initiate the one or more sub-queries for the data and the one or more locations; in response to the instructions received at each particular one of the one or more analytics agents at the one or more networked computing devices, performing: initiating execution of the sub-queries on the one or more data streams that are locally available at one of the one or more networked computing devices at which that particular one of the analytics agents is running; forming one or more summarized data streams and zero or more raw data streams at the one of the one or more networked computing devices at which that particular one of the analytics agents is running; sending the one or more summarized data streams and the zero or more raw data streams to the desired location at the analytics engine; wherein the method is performed by one or more computing devices.

2. The data processing method of clause 1 wherein the instructions comprise the identification of one or more particular input data streams, one or more analytics queries, result disposition information, and a data retention policy.

3. The data processing method of clause 1 wherein the one or more analytics agents are in any one or more of: a data packet router; a data packet switch; a blade of a data packet router; a virtual machine hosted in a computing device; a computing device that is coupled to one or more data packet routers and configured to collect analytics data from the one or more packet data routers.

4. The data processing method of clause 1 wherein the distributed network analytics controller is hosted in a first computer of a network operations center and the separate analytics application is hosted in a second computer of a network operations center.

5. The data processing method of clause 1, further comprising:

each of the one or more analytics agents interacting with each locally accessible network device to discover zero or more potential data sources that can be streamed from it;

each of the one or more analytics agents propagating informational advertisements about the data streams that are potentially locally available for analysis;

executing one or more discovery operations at the distributed network analytics controller that seek to discover network identities of the one or more analytics agents;

gathering, at the distributed network analytics controller, the informational advertisements and constructing a global meta data repository configured for the analytics engine to use in query rewriting.

6. The data processing method of clause 1, further comprising executing application programming interface (API) logic at the analytics engine that is configured to receive and reply to one or more API calls of the separate analytics application, wherein the API calls either specify the analytics query, or are translated into analytics queries by the analytics engine.

7. The data processing method of clause 1, further comprising, in response to the instructions, the one or more analytics agents at the one or more networked computing devices storing the one or more summarized data streams and the zero or more raw data streams in storage associated with the one or more networked computing devices.

8. The data processing method of clause 1, further comprising, in response to the instructions, the one or more analytics agents at the one or more networked computing devices interacting with locally accessible network devices in order to start the flow of a raw data stream with explicitly specified information attributes based on the instructions received.

9. The data processing method of clause 1, further comprising the one or more analytics agents receiving, as part of the instructions, one or more policies that specify how to perform the programmed analytics queries; wherein the executing, forming and sending are performed based on the one or more policy items.

10. The data processing method of clause 1, wherein the analytics query from the separate analytics application is a compound query and further comprising: sending, from the distributed network analytics controller to a first analytics agent hosted by a first one of the networked computing devices, first instructions to initiate a first analytics query for the data, wherein the first analytics query relates to the compound query; sending, from the distributed network analytics controller to a second analytics agent hosted by a second, different one of the networked computing devices, second instructions to initiate a second analytics query for the data, wherein the second analytics query also relates to the compound query; in response to the first instructions and the second instructions, the first analytics agent and the second analytics agent respectively sending, to the analytics application, a first summarized data stream resulting from the first programmed analytics query and a second summarized data stream resulting from the second programmed analytics query.

11. The data processing method of clause 1, further comprising providing results of a first sub-query executing on a first distributed network analytics node as additional input to one or more of: a second sub-query on a second distributed network analytics node; or the super-query running on the analytics engine.

12. The data processing method of clause 1, wherein the sending comprises sending to the first analytics agent on a first service blade of a data packet router and sending to the second analytics agent on a second, different service blade of the same data packet router.

13. A non-transitory computer-readable data storage medium storing one or more sequences of instruction which, when executed by one or more processors, cause performing a method comprising: receiving, at any of one or more analytics engines each hosted on one or more computing devices, from a separate analytics application, an analytics query for data that is potentially available in one or more data streams of one or more networked computing devices; rewriting the analytics query into one or more sub-queries configured to operate on specific raw data streams to produce resulting raw or summarized data streams, and a super-query that is configured to consolidate the resulting raw or summarized data streams to produce results for the analytics query; initiating, at the analytics engine, execution of the super-query; sending, from the analytics engine to a distributed network analytics controller, the one or more sub-queries and one or more locations to send the one or more resulting raw or summarized data streams; determining, at the distributed network analytics controller, one or more distributed network analytics agents capable of executing each of the one or more sub-queries; sending, from the distributed network analytics controller to one or more of the analytics agents respectively hosted by the one or more networked computing devices, programming instructions to initiate the one or more sub-queries for the data and the one or more locations; in response to the programming instructions received at each particular one of the one or more analytics agents at the one or more networked computing devices, performing: initiating execution of the sub-queries on the one or more data streams that are locally available at one of the one or more networked computing devices at which that particular one of the analytics agents is running; forming one or more summarized data streams and zero or more raw data streams at the one of the one or more networked computing devices at which that particular one of the analytics agents is running; sending the one or more summarized data streams and the zero or more raw data streams to the desired location at the analytics engine.

14. The non-transitory computer-readable data storage medium of clause 13 wherein the programming instructions comprise the identification of one or more particular input data streams, one or more analytics queries, result disposition information, and a data retention policy.

15. The data processing method of clause 13 wherein the one or more analytics agents are in any one or more of: a data packet router; a data packet switch; a blade of a data packet router; a virtual machine hosted in a computing device; a computing device that is coupled to one or more data packet routers and configured to collect analytics data from the one or more packet data routers.

16. The non-transitory computer-readable data storage medium of clause 13 wherein the distributed network analytics controller is hosted in a first computer of a network operations center and the separate analytics application is hosted in a second computer of a network operations center.

17. The non-transitory computer-readable data storage medium of clause 13, further comprising instructions which when executed cause: each of the one or more analytics agents interacting with each locally accessible network device to discover zero or more potential data sources that can be streamed from it; each of the one or more analytics agents propagating informational advertisements about the data streams that are potentially locally available for analysis; executing one or more discovery operations at the distributed network analytics controller that seek to discover network identities of the one or more analytics agents; gathering, at the distributed network analytics controller, the informational advertisements and constructing a global meta data repository configured for the analytics engine to use in query rewriting,

18. The non-transitory computer-readable data storage medium of clause 13, further comprising instructions which when executed cause executing application programming interface (API) logic at the analytics engine that is configured to receive and reply to one or more API calls of the separate analytics application, wherein the API calls either specify the analytics query, or are translated into analytics queries by the analytics engine.

19. The non-transitory computer-readable data storage medium of clause 13, further comprising instructions which when executed cause, in response to the programming instructions, the one or more analytics agents at the one or more networked computing devices storing the one or more summarized data streams and the zero or more raw data streams in storage associated with the one or more networked computing devices.

20. The non-transitory computer-readable data storage medium of clause 13, further comprising instructions which when executed cause, in response to the programming instructions, the one or more analytics agents at the one or more networked computing devices interacting with locally accessible network devices in order to start the flow of a raw data stream with explicitly specified information attributes based on the instructions received.

21. The non-transitory computer-readable data storage medium of clause 13, further comprising instructions which when executed cause the one or more analytics agents receiving, as part of the programming instructions, one or more policies that specify how to perform the programmed analytics queries; wherein the executing, forming and sending are performed based on the one or more policy items.

22. The non-transitory computer-readable data storage medium of clause 13, wherein the analytics query from the separate analytics application is a compound query and further comprising instructions which when executed cause: sending, from the distributed network analytics controller to a first analytics agent hosted by a first one of the networked computing devices, first instructions to initiate a first analytics query for the data, wherein the first analytics query relates to the compound query; sending, from the distributed network analytics controller to a second analytics agent hosted by a second, different one of the networked computing devices, second instructions to initiate a second analytics query for the data, wherein the second analytics query also relates to the compound query; in response to the first instructions and the second instructions, the first analytics agent and the second analytics agent respectively sending, to the analytics application, a first summarized data stream resulting from the first programmed analytics query and a second summarized data stream resulting from the second programmed analytics query.

23. The non-transitory computer-readable data storage medium of clause 13, further comprising instructions which when executed cause providing results of a first sub-query executing on a first distributed network analytics node as additional input to one or more of: a second sub-query on a second distributed network analytics node; or the super-query running on the analytics engine.

24. The non-transitory computer-readable data storage medium of clause 13, wherein instructions which when executed cause the sending comprise instructions which when executed cause sending to the first analytics agent on a first service blade of a data packet router and sending to the second analytics agent on a second, different service blade of the same data packet router.

25. Data processing apparatus comprising: a first computer configured to execute a network analytics application; a second computer that is coupled to the first computer and comprising a distributed network analytics controller; one or more distributed network analytics nodes, coupled to the second computer, and each comprising an analytics agent; receiving, at any of one or more analytics engines each hosted on one or more computing devices, from the network analytics application, an analytics query for data that is potentially available in one or more data streams of one or more networked computing devices; rewriting the analytics query into one or more sub-queries configured to operate on specific raw data streams to produce resulting raw or summarized data streams, and a super-query that is configured to consolidate the resulting raw or summarized data streams to produce results for the analytics query; initiating, at the analytics engine, execution of the super-query; sending, from the analytics engine to the distributed network analytics controller, the one or more sub-queries and one or more locations to send the one or more resulting raw or summarized data streams; determining, at the distributed network analytics controller, one or more analytics agents of the distributed network analytics nodes capable of executing each of the one or more sub-queries; sending, from the distributed network analytics controller to one or more of the analytics agents respectively hosted by the one or more networked computing devices, programming instructions to initiate the one or more sub-queries for the data and the one or more locations; in response to the programming instructions received at each particular one of the one or more analytics agents at the one or more networked computing devices, performing: initiating execution of the sub-queries on the one or more data streams that are locally available at one of the one or more networked computing devices at which that particular one of the analytics agents is running; forming one or more summarized data streams and zero or more raw data streams at the one of the one or more networked computing devices at which that particular one of the analytics agents is running; sending the one or more summarized data streams and the zero or more raw data streams to the desired location at the analytics engine; wherein the method is performed by one or more computing devices.

26. The data processing apparatus of clause 25 wherein the programming instructions comprise an identification of a particular input data stream, one or more programmed analytics queries, result disposition information, and a data retention policy.

27. The data processing apparatus of clause 25 wherein each analytics agent is in any one or more of: a data packet router; a data packet switch; a blade of a data packet router; a virtual machine hosted in a computing device; a computing device that is coupled to one or more data packet routers and configured to collect analytics data from the one or more packet data routers.

5.0 Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A data processing method comprising:
receiving, at any of one or more analytics engines each hosted on one or more computing devices, from a separate analytics application, an analytics query for data that is potentially available in one or more data streams of one or more networked computing devices;
rewriting the analytics query into one or more sub-queries configured to operate on specific raw data streams to produce resulting raw or summarized data streams, and a super-query that is configured to consolidate the resulting raw or summarized data streams to produce results for the analytics query;
initiating, at the analytics engine, execution of the super-query;
sending, from the analytics engine to a distributed network analytics controller, the one or more sub-queries and one or more locations to send the one or more resulting raw or summarized data streams;
determining, at the distributed network analytics controller, one or more distributed network analytics agents capable of executing each of the one or more sub-queries;
sending, from the distributed network analytics controller to one or more of the analytics agents respectively hosted by the one or more networked computing devices, instructions to initiate the one or more sub-queries for the data and the one or more locations;
in response to the instructions received at each particular one of the one or more analytics agents at the one or more networked computing devices, performing:
initiating execution of the sub-queries on the one or more data streams that are locally available at one of the one or more networked computing devices at which that particular one of the analytics agents is running;
forming one or more summarized data streams and zero or more raw data streams at the one of the one or more networked computing devices at which that particular one of the analytics agents is running;
sending the one or more summarized data streams and the zero or more raw data streams to the desired location at the analytics engine;
wherein the method is performed by one or more computing devices.

2. The data processing method of claim 1 wherein the instructions comprise the identification of one or more particular input data streams, one or more analytics queries, result disposition information, and a data retention policy.

3. The data processing method of claim 1 wherein the one or more analytics agents are in any one or more of: a data packet router; a data packet switch; a blade of a data packet router; a virtual machine hosted in a computing device; a computing device that is coupled to one or more data packet routers and configured to collect analytics data from the one or more packet data routers.

4. The data processing method of claim 1 wherein the distributed network analytics controller is hosted in a first computer of a network operations center and the separate analytics application is hosted in a second computer of a network operations center.

5. The data processing method of claim 1, further comprising:
each of the one or more analytics agents interacting with each locally accessible network device to discover zero or more potential data sources that can be streamed from it;
each of the one or more analytics agents propagating informational advertisements about the data streams that are potentially locally available for analysis;
executing one or more discovery operations at the distributed network analytics controller that seek to discover network identities of the one or more analytics agents;
gathering, at the distributed network analytics controller, the informational advertisements and constructing a global meta data repository configured for the analytics engine to use in query rewriting.

6. The data processing method of claim 1, further comprising executing application programming interface (API) logic at the analytics engine that is configured to receive and reply to one or more API calls of the separate analytics application, wherein the API calls either specify the analytics query, or are translated into analytics queries by the analytics engine.

7. The data processing method of claim 1, further comprising, in response to the instructions, the one or more analytics agents at the one or more networked computing devices storing the one or more summarized data streams and the zero or more raw data streams in storage associated with the one or more networked computing devices.

8. The data processing method of claim 1, further comprising, in response to the instructions, the one or more analytics agents at the one or more networked computing devices interacting with locally accessible network devices in order to start the flow of a raw data stream with explicitly specified information attributes based on the instructions received.

9. The data processing method of claim 1, further comprising the one or more analytics agents receiving, as part of the instructions, one or more policies that specify how to perform the programmed analytics queries;
wherein the executing, forming and sending are performed based on the one or more policy items.

10. The data processing method of claim 1, wherein the analytics query from the separate analytics application is a compound query and further comprising:
sending, from the distributed network analytics controller to a first analytics agent hosted by a first one of the networked computing devices, first instructions to initiate a first analytics query for the data, wherein the first analytics query relates to the compound query;
sending, from the distributed network analytics controller to a second analytics agent hosted by a second, different one of the networked computing devices, second instructions to initiate a second analytics query for the data, wherein the second analytics query also relates to the compound query;
in response to the first instructions and the second instructions, the first analytics agent and the second analytics agent respectively sending, to the analytics application, a first summarized data stream resulting from the first programmed analytics query and a second summarized data stream resulting from the second programmed analytics query.

11. The data processing method of claim 1, further comprising providing results of a first sub-query executing on a first distributed network analytics node as additional input to one or more of: a second sub-query on a second distributed network analytics node; or the super-query running on the analytics engine.

12. The data processing method of claim 1, wherein the sending comprises sending to the first analytics agent on a first service blade of a data packet router and sending to the second analytics agent on a second, different service blade of the same data packet router.

13. A non-transitory computer-readable data storage medium storing one or more sequences of instruction which, when executed by one or more processors, cause performing a method comprising:
receiving, at any of one or more analytics engines each hosted on one or more computing devices, from a separate analytics application, an analytics query for data that is potentially available in one or more data streams of one or more networked computing devices;
rewriting the analytics query into one or more sub-queries configured to operate on specific raw data streams to produce resulting raw or summarized data streams, and a super-query that is configured to consolidate the resulting raw or summarized data streams to produce results for the analytics query;
initiating, at the analytics engine, execution of the super-query;
sending, from the analytics engine to a distributed network analytics controller, the one or more sub-queries and one or more locations to send the one or more resulting raw or summarized data streams;
determining, at the distributed network analytics controller, one or more distributed network analytics agents capable of executing each of the one or more sub-queries;
sending, from the distributed network analytics controller to one or more of the analytics agents respectively hosted by the one or more networked computing devices, programming instructions to initiate the one or more sub-queries for the data and the one or more locations;
in response to the programming instructions received at each particular one of the one or more analytics agents at the one or more networked computing devices, performing:
initiating execution of the sub-queries on the one or more data streams that are locally available at one of the one or more networked computing devices at which that particular one of the analytics agents is running;
forming one or more summarized data streams and zero or more raw data streams at the one of the one or more networked computing devices at which that particular one of the analytics agents is running;
sending the one or more summarized data streams and the zero or more raw data streams to the desired location at the analytics engine.

14. The non-transitory computer-readable data storage medium of claim 13 wherein the programming instructions comprise the identification of one or more particular input data streams, one or more analytics queries, result disposition information, and a data retention policy.

15. The data processing method of claim 13 wherein the one or more analytics agents are in any one or more of: a data packet router; a data packet switch; a blade of a data packet router; a virtual machine hosted in a computing device; a computing device that is coupled to one or more data packet routers and configured to collect analytics data from the one or more packet data routers.

16. The non-transitory computer-readable data storage medium of claim 13 wherein the distributed network analytics controller is hosted in a first computer of a network operations center and the separate analytics application is hosted in a second computer of a network operations center.

17. The non-transitory computer-readable data storage medium of claim 13, further comprising instructions which when executed cause:
each of the one or more analytics agents interacting with each locally accessible network device to discover zero or more potential data sources that can be streamed from it;
each of the one or more analytics agents propagating informational advertisements about the data streams that are potentially locally available for analysis;
executing one or more discovery operations at the distributed network analytics controller that seek to discover network identities of the one or more analytics agents;
gathering, at the distributed network analytics controller, the informational advertisements and constructing a global meta data repository configured for the analytics engine to use in query rewriting.

18. The non-transitory computer-readable data storage medium of claim 13, further comprising instructions which when executed cause executing application programming interface (API) logic at the analytics engine that is configured to receive and reply to one or more API calls of the separate analytics application, wherein the API calls either specify the analytics query, or are translated into analytics queries by the analytics engine.

19. The non-transitory computer-readable data storage medium of claim 13, further comprising instructions which when executed cause, in response to the programming instructions, the one or more analytics agents at the one or more networked computing devices storing the one or more summarized data streams and the zero or more raw data streams in storage associated with the one or more networked computing devices.

20. The non-transitory computer-readable data storage medium of claim 13, further comprising instructions which when executed cause, in response to the programming instructions, the one or more analytics agents at the one or more networked computing devices interacting with locally accessible network devices in order to start the flow of a raw data stream with explicitly specified information attributes based on the instructions received.

21. The non-transitory computer-readable data storage medium of claim 13, further comprising instructions which when executed cause the one or more analytics agents receiving, as part of the programming instructions, one or more policies that specify how to perform the programmed analytics queries;
wherein the executing, forming and sending are performed based on the one or more policy items.

22. The non-transitory computer-readable data storage medium of claim 13, wherein the analytics query from the separate analytics application is a compound query and further comprising instructions which when executed cause:
sending, from the distributed network analytics controller to a first analytics agent hosted by a first one of the networked computing devices, first instructions to initiate a first analytics query for the data, wherein the first analytics query relates to the compound query;
sending, from the distributed network analytics controller to a second analytics agent hosted by a second, different one of the networked computing devices, second instructions to initiate a second analytics query for the data, wherein the second analytics query also relates to the compound query;
in response to the first instructions and the second instructions, the first analytics agent and the second analytics agent respectively sending, to the analytics application, a first summarized data stream resulting from the first programmed analytics query and a second summarized data stream resulting from the second programmed analytics query.

23. The non-transitory computer-readable data storage medium of claim 13, further comprising instructions which when executed cause providing results of a first sub-query executing on a first distributed network analytics node as additional input to one or more of: a second sub-query on a second distributed network analytics node; or the super-query running on the analytics engine.

24. The non-transitory computer-readable data storage medium of claim 13, wherein instructions which when executed cause the sending comprise instructions which when executed cause sending to the first analytics agent on a first service blade of a data packet router and sending to the second analytics agent on a second, different service blade of the same data packet router.

25. A method comprising:
receiving, at any of one or more analytics engines each hosted on one or more computing devices, from a separate analytics application, an analytics query for data that is potentially available in one or more data streams of one or more networked computing devices;
sending, to a distributed network analytics controller, one or more sub-queries based on the analytics query;
determining one or more distributed network analytics agents capable of executing each of the one or more sub-queries;
sending instructions to the agents to initiate the one or more sub-queries for the data at one or more specified locations;
initiating execution of the one or more sub-queries on one or more data streams that are locally available at one of the one or more networked computing devices at which the agents are running;
forming one or more summarized data streams and zero or more raw data streams at the one of the one or more networked computing devices of the analytics agents;
sending the one or more summarized data streams and the zero or more raw data streams to the analytics engine;
wherein the method is performed by one or more computing devices.

26. The method of claim 25, further comprising:
each of the one or more analytics agents interacting with each locally accessible network device to discover zero or more potential data sources that can be streamed from it;
each of the one or more analytics agents propagating informational advertisements about the data streams that are potentially locally available for analysis;
gathering, at the distributed network analytics controller, the informational advertisements and constructing a global meta data repository configured for the analytics engine to use in query rewriting.

27. The method of claim 1, wherein the analytics query is a compound query and further comprising:
sending, from the distributed network analytics controller to a first analytics agent hosted by a first one of the networked computing devices, first instructions to initiate a first analytics query for the data, wherein the first analytics query relates to the compound query;
sending, from the distributed network analytics controller to a second analytics agent hosted by a second, different one of the networked computing devices, second instructions to initiate a second analytics query for the data, wherein the second analytics query also relates to the compound query;
in response to the first instructions and the second instructions, the first analytics agent and the second analytics agent respectively sending, to the analytics application, a first summarized data stream resulting from the first programmed analytics query and a second summarized data stream resulting from the second programmed analytics query.
